(19) United States
(12) Patent Application Publication
(10) Pub. No.: US 2014/0238242 A1
(43) Pub. Date: Aug. 28, 2014

(54) CERAMIC PARTIAL WALL-FLOW FILTER WITH LOW DEEP BED

(71) Applicant: Corning Incorporated, Corning, NY (US)

(72) Inventors: Suhao He, Painted Post, NY (US); Achim Karl-Erich Heibel, Corning, NY (US)

(73) Assignee: Corning Incorporated, Corning, NY (US)

(21) Appl. No.: 14/108,444

(22) Filed: Dec. 17, 2013

Related U.S. Application Data
(60) Provisional application No. 61/770,514, filed on Feb. 28, 2013.

(51) Int. Cl. F01N 3/022; B01D 46/24

(52) U.S. Cl. CPC F01N 3/0222; B01D 46/2425
USPC 95/278; 55/523; 95/273

(57) ABSTRACT

A partial wall-flow filter, having a honeycomb structure including an inlet end, an outlet end, and parallel channels disposed and configured to flow fluid from the inlet end to the outlet end. The channels are defined by a plurality of intersecting porous walls. The partial wall-flow filter has a filtration region of channels plugged at the outlet end and a bypass region of unplugged channels. An N/S ratio of the filter material is less than or equal to about 0.5, less than or equal to about 0.3, less than or equal to about 0.1, or even 0, where N is a pressure drop difference induced by deep bed soot and S is a pressure drop change from 0 grams per liter (g/l) to about 5 g/l for a conditioned curve induced by cake bed soot, where N and S are measured on a full wall-flow filter of the filter material.

This application claims the benefit of priority under 35 U.S.C. §119 of U.S. Provisional Application Ser. No. 61/770,514 filed on Feb. 28, 2013 the content of which is relied upon and incorporated herein by reference in its entirety.

### BACKGROUND

1. Field

Exemplary embodiments of the present disclosure relate to a ceramic partial wall-flow filter having enhanced filtration performance and methods to operate an exhaust system having the ceramic partial wall-flow filter to enhance filtration performance.

2. Discussion of the Background

Exhaust gas aftertreatment systems for internal combustion engines may include, for example, a particulate filter (PF) for removing particulates from the exhaust gas stream, such as soot from diesel exhaust. The most widely used particulate filters are wall-flow filters. A wall-flow filter may include a ceramic honeycomb body having longitudinal, substantially parallel cell channels formed by a plurality of intersecting porous walls. Some of the cell channels may be plugged with a ceramic plugging cement to form a pattern of plugs at the end faces of the honeycomb body. The cell channels of the filter may have some ends unplugged at an inlet end of the honeycomb body to act as inlet channels. The inlet channels may be plugged at the outlet end of the honeycomb substrate. The remaining cell channels may be plugged at the inlet end of the honeycomb substrate with some ends unplugged at an outlet end of the honeycomb substrate to act as outlet channels. In use, exhaust gas containing entrained soot particles enters into the unplugged inlet channels, flows through the porous walls (wall-flow) and into the outlet channels, and exits through the unplugged outlet channels, wherein the porous walls retain a portion of the particles that were previously entrained in the exhaust gas.

In wall-flow filter designs, every channel may be plugged at the inlet end or the outlet end of the honeycomb substrate such that exhaust gas enters open channels on the inlet end. The inlet channels are plugged at the outlet end, and so the gas is forced to travel through the porous wall into an adjacent channel which is open at the outlet end but plugged at the inlet end to exit the filter. Filtration of the particulate matter is accomplished as the gas is forced to pass through the porous wall. Filtration efficiencies greater than 90% have been realized with wall-flow filters.

Wall-flow filters may be cleaned to prevent the filter from becoming blocked and to maintain a suitable pressure drop across the filter below a prescribed limit. Increase in pressure drop across the filter generally results in an increase in backpressure against the engine which, if not controlled, may lead to undesirable power loss. One method for cleaning the filter is to remove the soot trapped in the filter by thermal regeneration. The regeneration may be either passive or active or a combination thereof. In passive regeneration, the inlet temperature of the exhaust gas entering the filter is sufficiently high to initiate combustion of the soot trapped in the wall-flow filter on a generally continuous basis, once steady state engine operating conditions are met. In active regeneration, the location of the filter is such that the temperature of the filter is relatively low and additional energy input may be required to raise the temperature of the exhaust (and the filter) to a level that causes combustion of the soot trapped in the filter. The additional energy input may be provided by post injection of fuel into the exhaust in combination with an oxidation catalyst located upstream of the filter.

Exhaust aftertreatment systems based on active regeneration have become the industry standard because they desirably operate at lower exhaust temperatures and assure suitable soot removal under different engine duty cycles by actively initiating regeneration. On the other hand, active regeneration comes with a fuel economy penalty. Further, wall-flow filters may exhibit relatively high back pressure.

Partial wall-flow filters include, for example, any ceramic honeycomb body that is partially wall-flow, as described above, and partially flow-through wherein some of the channels or porous networks or other passages are open at both ends and permit the flow of exhaust gas containing entrained soot particles through the cell channels from the inlet end to the outlet end of the honeycomb substrate. Partial wall-flow filters may be used in aftertreatment systems, for example, retrofit, off-road diesel, and gasoline, that lack sophisticated controls, soot load estimation, or advanced regeneration strategies to regulate pressure drop through controlled active regeneration. In such systems partial wall-flow filters may exhibit a relatively low pressure drop at low soot loads and allow particulate matter to bypass at high soot loads until the filter can be regenerated under driving conditions conducive to passive regeneration.

The above information disclosed in this Background section is only for enhancement of understanding of the background of the claimed invention and therefore it may contain information that does not form any part of the prior art nor what the prior art may suggest to a person of ordinary skill in the art.

### SUMMARY

Exemplary embodiments of the present disclosure provide a partial wall-flow particulate filter with low deep bed soot load for improved filtration efficiency.

Exemplary embodiments of the present disclosure also provide a method of operating an exhaust system including the partial wall-flow particulate filter with low deep bed soot load for improved filtration efficiency.

Additional features of the claimed invention will be set forth in the description which follows, and in part will be apparent from the description, or may be learned by practice of the claimed invention.

An exemplary embodiment discloses a partial wall-flow filter. The partial wall-flow filter includes a honeycomb structure having an inlet end, an outlet end, and parallel channels disposed and configured to flow fluid from the inlet end to the outlet end, the channels being defined by a plurality of porous walls. The partial wall-flow filter includes at least one filtration region and at least one bypass region, wherein the filtration region comprises a channel plugged at the outlet end, and the bypass region comprises an unplugged channel. An N/S ratio of the filter material is less than or equal to about 0.5, where N is a pressure drop difference induced by deep bed soot and S is a pressure drop change from 0 grams per liter (g/L) to about 5 g/L for a conditioned curve induced by cake bed soot, where N and S are measured on a full wall-flow filter of the filter material.

An exemplary embodiment also discloses a method of operating an exhaust system including directing exhaust gas having particulate matter entrained to the partial wall-flow filter. The method includes passing the exhaust gas having the particulate matter entrained through the partial wall-flow filter so that some of the particulate matter is captured and some passes through the flow through channels.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the claimed invention and are incorporated in and constitute a part of this specification, illustrate exemplary embodiments of the disclosure, and together with the description serve to explain the principles of the claimed invention.

FIGS. 1A and 1B are schematic diagrams of diesel exhaust systems according to exemplary embodiments of the disclosure.

FIG. 2A is a perspective view of a partial wall-flow filter according to exemplary embodiments of the disclosure for use in the exhaust systems of FIGS. 1A and 1B. FIG. 2B is an enlarged portion of the inlet end of the partial wall-flow filter of FIG. 2A, showing all channels unplugged at the inlet end.

FIG. 3 is a cross-sectional illustration of a partial wall-flow filter according to exemplary embodiments of the disclosure, showing no channels plugged at the inlet end and large channels plugged at an exit end of the filter.

FIG. 4 is an enlarged portion of the exit end of the partial wall-flow filter of FIG. 2A, showing large channels plugged at the exit end of the filter according to exemplary embodiments of the disclosure.

FIG. 5 is a schematic representation of pressure drop response as function of soot load for a full wall-flow particulate filter.

FIG. 6 is a schematic representation of flow distribution for a partial wall-flow filter according to an exemplary embodiment of the disclosure.

FIG. 7 is a schematic representation of filtration efficiency as a function of soot load for a full wall-flow particulate filter.

FIG. 8 is a schematic representation of pressure drop response for a full wall-flow filter.

FIG. 9A is a schematic diagram showing a coating disposed on the porous walls of a filtration region channel (inlet channel) and FIG. 9B is a schematic diagram showing a coating disposed on the porous walls of a bypass region channel (outlet channel) according to an exemplary embodiment of the disclosure.

FIG. 10 is a graphical plot of data demonstrating an improvement in filtration efficiency with conditioning.

### DETAILED DESCRIPTION OF THE ILLUSTRATED EMBODIMENTS

The disclosure is described more fully hereinafter with reference to the accompanying drawings, in which exemplary embodiments are shown. The claims may, however, be embodied in many different forms and should not be construed as limited to the embodiments set forth herein. Rather, these embodiments are provided so that this disclosure is thorough, and will fully convey the scope of the claims to those skilled in the art. In the drawings, the size and relative sizes of layers and regions may be exaggerated for clarity. Like reference numerals in the drawings denote like elements.

It will be understood that when an element is referred to as being “on” or “connected to” another element, it can be directly on or directly connected to the other element, or intervening elements may be present. In contrast, when an element is referred to as being “directly on” or “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

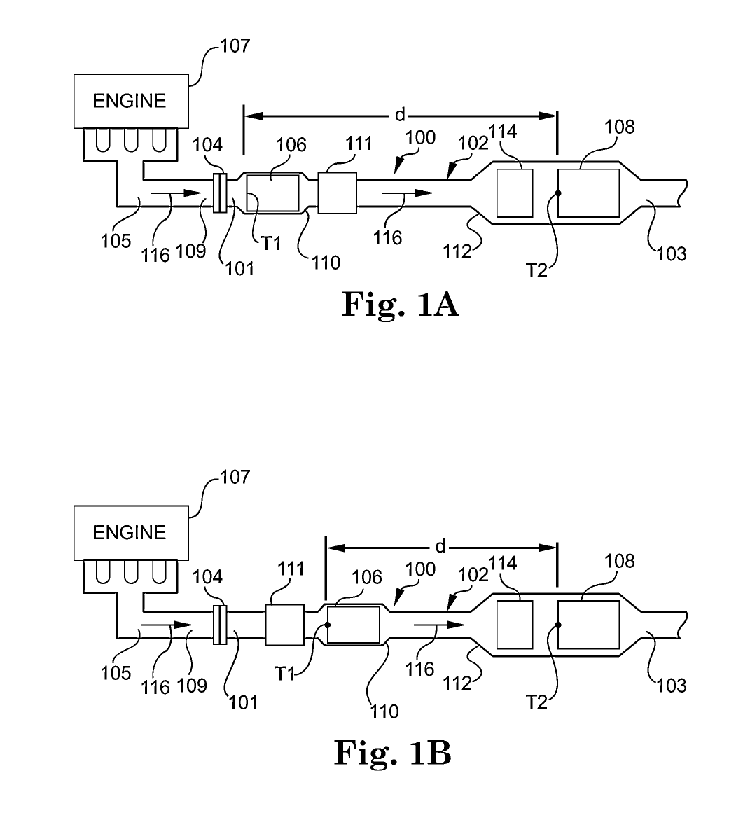

FIG. 1A depicts an exhaust system 100 for venting exhaust from an exhaust manifold 105 of an internal combustion engine 107, such as a diesel engine or a gasoline engine. The exhaust system 100, as shown, includes an exhaust line 102 with inlet end 101 and outlet end 103. The inlet end 101 is coupled to the engine 107 through an exhaust manifold 105. The inlet end 101 may include a connection device 104, which may take on any suitable form. For example, the connection device 104 may be a flange that can be coupled to a similar flange on a connection portion 109 of the exhaust manifold 105. Although the exhaust line 102 is shown as being generally straight, in practice it may take on other profiles and may include straight and curved sections and/or sections of differing diameter.

The exhaust system 100 includes a first particulate filter 106 disposed adjacent to the inlet end 101 of the exhaust line 102 such as partial wall-flow filter described herein. The first filter 106 may be in a “close-coupled” position with respect to the engine 107 and, of course, also the exhaust manifold 105. In this “close-coupled” position, the first particulate filter 106 may take advantage of the higher incident exhaust temperatures to effect a substantially greater extent of “passive” regeneration of the captured soot, as compared to a downstream (second) filter. The term “close-coupled” as used herein, means the filter is in a location in the exhaust stream in close proximity to the engine 107, and, in particular, in close proximity to the combustion chambers of the engine, as measured along the path of the exhaust stream. For example, the first filter 106 positioned right after the exhaust manifold 104 if no turbocharger 111 is present is close coupled (FIG. 1A). For example, when the turbocharger 111 is present, the first filter 106 right after the turbocharger 111 is close-coupled (FIG. 1B). In one example shown in FIG. 1A, a turbocharger 111 is positioned in the exhaust line 102 and the first particulate filter 106 is positioned upstream of the turbocharger 111 such that the hot gases directly impinge upon the first filter 106. In another embodiment, the first filter 106 is located directly downstream of the turbocharger 111 (See FIG. 1B). In the close-coupled position, the first filter 106 may experience temperature conditions of 250° C. or greater for a substantial amount, greater than 10%, or even greater than 20%, of the operating cycle. These conditions promote a substantial amount of “passive” regeneration.

In some embodiments, the exhaust system 100 may further include a second particulate filter 108 positioned in the exhaust line 102, and spaced a distance (d) from the first particulate filter 106. In the examples shown in FIG. 1A, 1B, the second particulate filter 108 may be positioned downstream of a turbocharger 111. Additional particulate filters may be positioned in the exhaust line 102, downstream of the second particulate filter 108 to meet desired filtration and backpressure requirements. The second particulate filter 108 may be preceded by an upstream oxidation catalyst 114. While not shown in the drawings, the first particulate filter 106, for example, can also be preceded by an upstream diesel oxidation catalyst (DOC). For example, for heavy duty diesel (HDD) applications, an arrangement may include an oxidation catalyst 114 between the manifold 104 and the first particulate filter 106 where the oxidation catalyst 114 and the first particulate filter 106 may be in an under body (UB) location. As another example, for light duty diesel (LDD) applications, an arrangement may include an oxidation catalyst 114 between the manifold 104 and the first particulate filter 106 where the oxidation catalyst 114 and the first particulate filter 106 may be in a close-coupled location and the second particulate filter 108 in an UB location. In the example of a diesel engine 107, the oxidation catalyst would be a diesel oxidation catalyst (DOC), which may incorporate any known active catalytic species for purifying exhaust, such as catalytic species for oxidizing carbon monoxide, hydrocarbons, and soluble organic fraction of particulates, as is known in the art. The exhaust system 100 may further include devices such as diffusion and expansion cones 110, 112 at the inlet and outlet ends of the particulate filters 106, 108 to aid in achieving desired exhaust flow distribution in the particulate filters, and/or size and weight reductions in the exhaust line 102.

During normal operation of the engine 107, such as during the operation of a diesel engine, exhaust from the engine 107 and exhaust manifold 105 passes sequentially through the first particulate filter 106, turbocharger 111 (if present), oxidation catalyst 114 (if present), and second particulate filter 108, as indicated by arrows 116 in FIG. 1A. Particulates in the exhaust are trapped inside the first and second particulate filters 106, 108 as the exhaust passes through them. In particular, part of the soot is trapped in the first filter, while some of the remaining soot is trapped in the second filter. The first particulate filter 106 and the second particulate filter 108 may both be in a close-coupled location or the first particulate filter 106 and the second particulate filter 108 may both be in an UB location.

According to some embodiments, the first particulate filter 106 may be a partial wall-flow filter. A partial wall-flow filter as defined herein is a particulate filter having porous walls forming channels wherein some of the channels are plugged in a filtration region and some of the channels are completely unplugged (“flow-through channels”) in a bypass region. Such a partial wall-flow filter generally has a relatively low pressure drop in comparison to full wall-flow filters wherein in the full wall-flow filter case all the channels are plugged (e.g. at either the inlet end or the outlet end). According to some other embodiments, second particulate filter 108 is also a partial wall-flow filter. In some other embodiments, only one of the filters 106 and 108 is a partial wall-flow filter. In some other embodiments, only one of the filters 106 and 108 is used in exhaust system 100.

In one example, the first particulate filter 106 may be small enough to fit into the available space near the exhaust manifold 105, between the exhaust manifold 105 and the turbocharger 111, or just downstream of the turbocharger 111. The physical space (volume) needed to house the first particulate filter 106 may be relatively smaller than the space (volume) to house the second filter 108, because the second particulate filter 108 provides the additional volume needed to meet filtration requirements. In one implementation, the second particulate filter 108 may be a full wall-flow filter, for example. However, a full wall-flow filter would typically not be suitable for use as the first particulate filter 106 because of the size and pressure drop requirements for a filter in a “close-coupled” position. In particular, it is desirable that the first filter exhibit low pressure drop. Because of the low pressure drop requirement, the first particulate filter 106 may provide a lower filtration efficiency (i.e., capture a lower percentage of the particulates in the exhaust) as compared to the second particulate filter 108. As an example, the first particulate filter 106 may have an initial or “clean” filtration efficiency (FE @ 0 g/L) of less than about 80%. However, according to some embodiments, initial filtration efficiencies FE@ 0 g/L≧20% are achievable, or FE@ 0 g/L≧30%, FE@ 0 g/L≧40%, or even FE@ 0 g/L≧50%. As used herein, filtration efficiency (FE) is expressed as a percentage at a particular soot loading in the filter (i.e., grams of soot per liter of filter volume, or g/L). A “clean” filter will have a soot loading of zero (0) g/L.

In one broad aspect, a partial wall-flow filter as disclosed herein comprises a plurality of porous walls forming channels having asymmetric sizes, wherein some plugged channels and some unplugged flow-through channels are present. In one embodiment, adjacent channels are asymmetric in size and defined by hydraulic diameters Dh1 and Dh2, such that the ratio of Dh1 and Dh2 is between 1.1 and 1.6. In one embodiment, the channels are unplugged at the inlet end of the filter, and the larger channels (having hydraulic diameter Dh1) are plugged on the outlet end of the filter. In one embodiment, all of the larger channel are plugged at the outlet end. In another embodiment, less than all of the larger channels are plugged at the outlet end, such that some of the larger channels are flow-through channels. In one embodiment, the filter has a length to diameter ratio between 0.2 and 3. In some embodiments, the porous walls of the filter have a transverse thickness (t), where t≦457 μm. In some embodiments, the porous walls of the filter have a mean pore diameter (MPD), where MPD≦20 μm. In some embodiments, the porous walls of the filter have a total porosity (% P), where % P≧40%. In some embodiments, the channels of the filter have a cell density (CD), where CD≧200 cells per square inch (cpsi). In some embodiments, the filter has combinations of the above described wall thickness t, mean pore diameter MPD, total porosity % P, and/or cell density CD.

According to another aspect, a method of operating an exhaust system is provided, comprising providing a partial wall-flow filter having plurality of porous walls forming channels having asymmetric sizes, wherein some plugged channels and some unplugged flow-through channels are present. In one embodiment, adjacent channels are asymmetric in size and defined by hydraulic diameters Dh1 and Dh2, such that the ratio of Dh1 and Dh2 is between 1.1 and 1.6. In one embodiment, the channels are unplugged at the inlet end of the filter, and the larger channels (having hydraulic diameter Dh1) are plugged on the outlet end of the filter. In one embodiment, all of the larger channel are plugged at the outlet end. In another embodiment, less than all of the larger channels are plugged at the outlet end, such that some of the larger channels are flow-through channels. In one embodiment, the filter has a length to diameter ratio between 0.2 and 3. In some embodiments, the porous walls of the filter have a transverse thickness (t), where t≦457 μm. In some embodiments, the porous walls of the filter have a mean pore diameter (MPD), where MPD≦20 μm. In some embodiments, the porous walls of the filter have a total porosity (% P), where % P≧40%. In some embodiments, the channels of the filter have a cell density (CD), where CD≧200 cells per square inch (cpsi). In some embodiments, the filter has combinations of the above described wall thickness t, mean pore diameter MPD, total porosity % P, and/or cell density CD.

As described herein, partial filters with asymmetric channel sizes that are not plugged on the inlet end and have at least a portion of the large channels plugged on the outlet end result in filter performance that yields high filtration efficiency (for example, >50%) and low pressure drops at low soot loadings (that is, near 0 g/L), and low filtration efficiency (for example, <10%) at high soot loading levels (>5 g/L). The slope of filtration efficiency (FE) vs. soot load can be further increased by having a filter where not all the large channels are blocked on the outlet end of the filter. The number of unplugged large channels is determined by the minimum filtration efficiency requirement at low soot load levels.

Further embodiments include a partial wall-flow filter having excellent properties for use in exhaust systems such as described above. It should be recognized that the partial wall-flow filter can be utilized in an exhaust system as the only exhaust treatment component in the system. For example, the system may include only a partial wall-flow filter, either being catalyzed or uncatalyzed. Optionally, the partial wall-flow filter may be used in combination with other conventional exhaust treatment components, and the partial wall flow filter is the only filter in the system. For example, oxidation catalyst (e.g., a DOC) or NOx treatment components may be employed in combination with the partial wall-flow filter. The partial wall-flow filter may be, for example, preceded by an upstream oxidation catalyst component. As discussed, a catalyst may be applied to the walls of the partial wall-flow filter, such as for treating carbon monoxide, hydrocarbons, and/or nitrogen oxides, such as an oxidation catalyst, selective catalytic reduction catalyst, lean NOx trap catalyst, or a lean NOx catalyst. An oxidation catalyst may contain suitable noble metals such as platinum, rhodium, and palladium. A selective catalytic reduction catalyst may include oxides of base metals containing, for example, vanadium, tungsten, titania, ceria, zirconia, ceria-zirconia, iron, and others as well mixtures thereof, zeolite materials of different crystalline structure such as FAU, MFI, MEL, BEA, CHA and others; SAPO materials of different crystalline structure. A lean NOx trap catalyst may include, for example, a mixture of a storage material containing an alkaline earth metal such as, for example, Ba, K, Li, Na, Ca, and Sr, in combination with a high surface area oxide material such as for example alumina, ceria, zirconia, tungsten, silica, etc, or mixtures thereof, and a precious metal such as, for example, Pt, Rh, and Pd. A lean NOx catalyst is a variety of zeolite- or alumina-based, precious or base metal based catalyst.

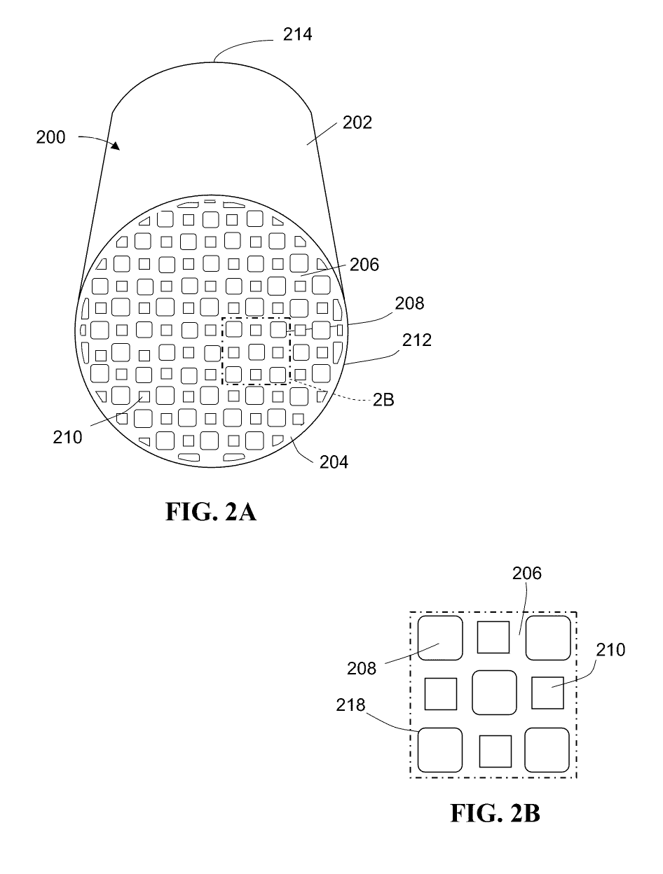

Now describing a honeycomb partial wall-flow filter 200 having asymmetric channel sizes in more detail, an example embodiment is shown and described with reference to FIGS. 2A and 2B. FIG. 2A shows partial filter 200 has a columnar body 202 whose cross-sectional shape is defined by a skin (or peripheral wall) 204. The profile of the skin 204 is typically circular or elliptical, but embodiments are not limited to any particular skin profile. The columnar body 202 has an array of interconnecting porous walls 206, which intersect with the skin 204. The porous walls 206 define a grid of first channels 208 and second channels 210 in the columnar body 202. The first and second channels 208, 210 extend longitudinally along the length of the columnar body 202. First channels 208 have a first hydraulic diameter Dh1, and second channels 210 have a second hydraulic diameter Dh2. In one embodiment, the ratio of Dh1 and Dh2 is between 1.1 and 1.6. However, in another embodiment the ratio of Dh1 and Dh2 may include 1.0. Typically, the columnar body 202 is made by extrusion. Typically, the columnar body 202 is made of a ceramic material, such as cordierite, aluminum titanate, or silicon carbide, but could also be made of other extrudable materials, such as glass, glass-ceramics, metal, and a variety of oxides of metal. The honeycomb filter 200 has an inlet end 212 for receiving flow, e.g., exhaust gas flow, and an outlet or exit end 214 through which filtered flow can exit the honeycomb filter.

The partial wall-flow filter 200 is so named because it exhibits a combination of plugged channels and unplugged flow-through channels. In the unplugged flow-through channels of a bypass region, flow is generally straight through the channel, i.e., not through the wall. In the plugged channels of a filtration region some of the flow passes through the walls. Thus, the “partial” indicates that only a part of the flow is through the porous wall, whereas part of the flow passes through the filter without flowing through a wall.

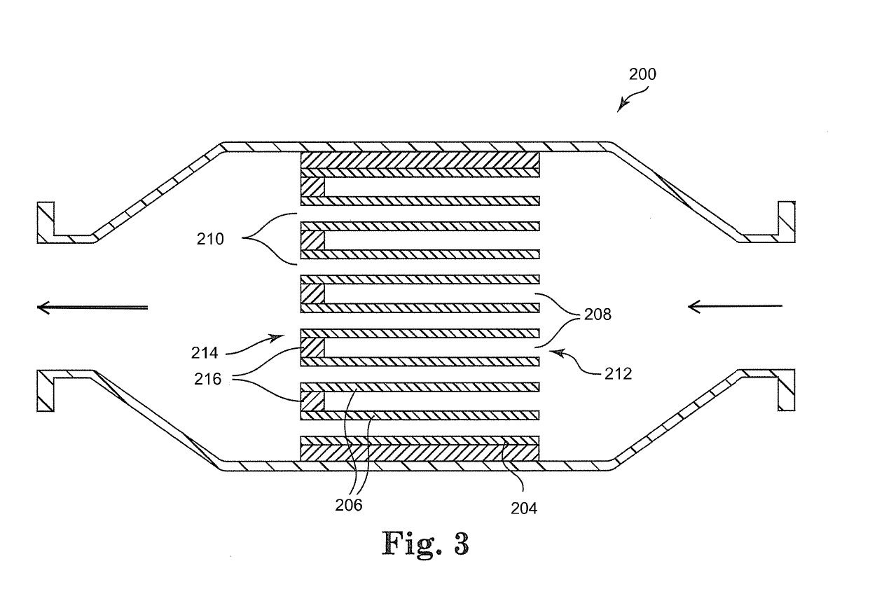

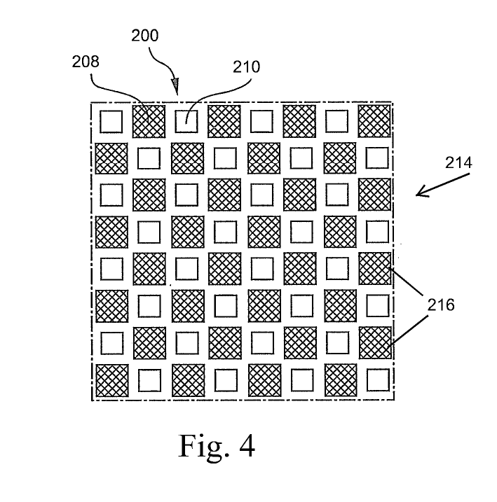

In one embodiment, at least a portion of the first set of channels 208 are plugged channels, and the second set of channels 210 are unplugged flow-through channels. This differs from the full wall-flow filter where all the channels 208, 210 are all end-plugged (at either the inlet end 212 or the outlet end 214). The channels 208 are plugged adjacent to an outlet end 214 of the filter, that is, at or near the outlet end 214 (FIG. 3 and FIG. 4). Embodiments including this configuration and high wall porosity, greater than 45%, exhibit relatively minimal pressure drop as a function of soot loading. In some embodiments, plugs 216 may be provided at, for example, an outlet end 214 of the channels 208. In other embodiments, the plugs 216 may be provided at locations spaced in from the outlet end. Typically, the material of plugs 216 is made of a ceramic material, such as cordierite, aluminum titanate, or silicon carbide.

In some embodiments, plugs 216 may be provided at, for example, an outlet end 214 of less than all of the channels 208, leaving a portion of channels 208 open (unplugged) as flow-through channels. In some embodiments, the unplugged, flow-through channels 208, which are unplugged along their length, are evenly distributed among the plugged channels 208 across the face of the filter.

FIG. 2B shows a close-up view of the channel structure of the honeycomb filter 200. Each of the first channels 208 is bordered by second channels 210 and vice versa. The honeycomb filter 200 may be comprised of large and small channels 208, 210, respectively, having large and small hydraulic diameters. However, according to another exemplary embodiment, the channels 208, 210 may have the same size and hydraulic diameters. In the illustration, the channels 208, 210 have a generally square geometry. In some embodiments, corners of the channels may be provided with fillets or bevels. In one embodiment, the dimension of the fillets or bevels may be selected such that hydraulic diameter of the larger cells 208 is maximized for a selected cell density and closed frontal area.

Hydraulic diameter, D_{H}, of a cell is defined as follows:

$${D}_{H} = \frac{4 A}{P} \qquad ( 1 )$$

where A is the cross-sectional area of the cell and P is the wetted perimeter of the cell. For a square cell, the hydraulic diameter is the width of the cell. For a square cell with filleted corners, the hydraulic diameter is larger than the width of the cell.

A cross-sectional schematic illustration of partial wall-flow filter 200 according to this disclosure is shown and described with reference to FIG. 3. In FIG. 3 and FIG. 4, it is shown that the filter 200 includes plugged channels 208 and unplugged channels 210. The plugs 216 are all positioned at the outlet end 214 of the filter 200. In this embodiment, approximately 50% of the channels are plugged and the remainder comprises flow-through channels.

According to further embodiments of the partial wall-flow filter described herein, it has been discovered that combinations of good initial filtration efficiency (@ 0 g/L soot loading) and relatively low back pressure may be achieved. According to embodiments, the following features in partial wall-flow filter 200, when provided either singly, or in combination, have been found to yield desirable filter properties. A honeycomb filter having asymmetric channel sizes, where the hydraulic diameter ratio between larger and smaller channels is between 1.1 and 1.6, having no channels plugged on the inlet end and having all of the larger channels plugged at the outlet end, with a filter diameter to length ratio of 0.2 and 3, resulted in filter performance having low pressure drop and high filtration efficiency for low levels of soot loading (<1 g/L) and low filtration efficiency at high soot loading levels (>5 g/L). For example, it is possible to achieve higher deep bed filtration efficiency even when the filter total porosity (% P) is % P≧45%, or even % P≧60%. Thus, simultaneously relatively low back pressure and good deep bed filtration efficiency may be obtained. Increases in wall thickness (t) have been found to influence pressure drop significantly with only marginal effect on filtration efficiency. Thus, the transverse thickness (t wall) of the porous walls 206, may be t wall≦457 μm, t wall≦254 μm, or even t wall≦203 μm, while only marginally affecting back pressure. Also, increasing the mean pore diameter (MPD) of the porous walls 206 increases deep bed mode filtration efficiency while only slightly decreasing back pressure. Thus, the porous walls 206 may incorporate pores having a mean pore diameter (MPD) wherein MPD≦20 μm, or even MPD≦15 μm; in some embodiments 12 μm≦MPD≦30 μm. Additionally, deep bed filtration efficiency increases significantly with higher channel cell density (CD) with only a modest increase in back pressure. Accordingly, the partial wall-flow filter 200 may have a channel cell density (CD) wherein CD≧200 cpsi (CD≧30 cells/cm²), or even CD≧300 cpsi (CD≧45 cells/cm²).

The partial wall-flow filter 200 includes a porous honeycomb body 202 having, for example, a generally cylindrical shape. The transverse cross-section of the honeycomb body 202 may be circular, oval, elliptical, square, or may have other desirable shape. The honeycomb body 202 has inlet end face 212, outlet end face 214, and interior porous walls 206 extending between the inlet and outlet ends 212, 214. The channels 208, 210 may have a square cross-section or other type of cross-section, e.g., triangle, circle, octagon, rectangle, hexagon or combinations thereof. The honeycomb substrate 202 is preferably made of a porous ceramic material, such as cordierite, aluminum titanate, or silicate carbide or other like ceramic material particularly whose open interconnected porosity may be controlled.

In a partial wall-flow filter 200 having asymmetric channel sizes with plugs 216 on only one side (e.g., at exit end 214), partial filtration occurs by passage of exhaust through some of the walls 206, while some flow passes straight through the filter (i.e., not through a wall 206). When the plugs 216 are positioned adjacent to the outlet end 214 of the filter (as shown in FIG. 3), a pressure differential between plugged and unplugged flow-through channels results in transfer of exhaust from plugged channels to unplugged, flow-through channels, and soot may be accumulated in the plugged channels.

Filters with combinations of plugged channels and unplugged, flow-through channels where % P≧45%, and even % P≧60% have been found to be particularly effective as a first filter promoting high soot capture in the first filter and exhibiting low pressure drop.

In one embodiment, the partial wall-flow filter with asymmetric channel sizes comprises a honeycomb body plugged at the outlet end 214 in a checkerboard pattern (alternately plugged and unplugged channels), with the large channels plugged at the outlet end 214 and all of the channels 208, 210 unplugged at the inlet end 212. In another embodiment, the partial wall-flow filter with asymmetric channel sizes comprises a honeycomb body plugged at the outlet end 214, with only a fraction of the large channels 208 plugged (e.g., less than all of the large channels 208 are plugged), and all of the channels 208, 210 are unplugged at the inlet end. The fraction of the large channels plugged is more than 20%, more preferably more than 60% and even more preferably more than 90% of the total number of large channels at the outlet end.

FIG. 4 shows a partial plugging pattern for a partial wall-flow filter 200 including unplugged, flow-through channels 210 and plugged channels 208, wherein the hydraulic diameters of the plugged and unplugged, flow-through channels are different. In particular, the hydraulic diameter of the plugged channels 208 are larger than the hydraulic diameter of the unplugged, flow-through channels 210. The plugged channels are located adjacent to the outlet end 214. In particular, an area ratio of the plugged area to open area of the filter is preferably 1.1 or more, 1.2 or more, or even 1.3 or more.

Soot particles are trapped by the channel walls in the filtration region of the filter when exhaust flows through channel walls through a combination of depth filtration and surface filtration, where surface filtration starts once a layer of soot cake is formed over the filter walls (cake bed soot). Compared to cake bed soot, soot trapped inside the wall (deep bed soot) creates a much higher pressure drop response for the same amount of soot. This is the deep bed response. The deep bed response induces higher flow resistance through the channel wall and thus less flow occurs through the channel wall, leading to less filtration efficiency. By managing deep bed soot according to exemplary embodiments of the present disclosure, improved filtration efficiency can be achieved.

According to exemplary embodiments filtration performance can be maintained and enhanced under various driving (engine operation) and soot load conditions. According to the exemplary embodiments filtration performance can be enhanced by deep bed soot management. According to the exemplary embodiments deep bed soot management includes, raw material optimization, for example, a ceramic material may have less deep bed response in its bare state (e.g., when clean). Deep bed soot management includes coating optimization, for example, a coating that creates less deep bed effects compared to a bare filter, or a coating disposed in an optimized location, for example, a coating disposed on the walls of a flow-through channel at the outlet end. Deep bed soot management also includes an operation strategy that ensures clean wall microstructure and a minimum amount of soot or ash layer covering the filtration surface area.

According to the exemplary embodiments raw material optimization may include a filter's microstructural properties, such as, for example, pore size, porosity and/or pore size distribution determined in accordance with various exemplary embodiments of the present teachings may be sufficient to provide a low clean pressure drop across the filter, as well as a low pressure drop response to soot loading of the filter during the deep bed filtration stage. Additionally, a filter's geometric properties, such as, for example, cell density (i.e., cells per square inch (cpsi)), wall thickness, filter length and/or filter diameter determined in accordance with various further exemplary embodiments of the present teachings may be sufficient to provide management of the deep bed response to soot loading of the filter during the deep bed filtration stage.

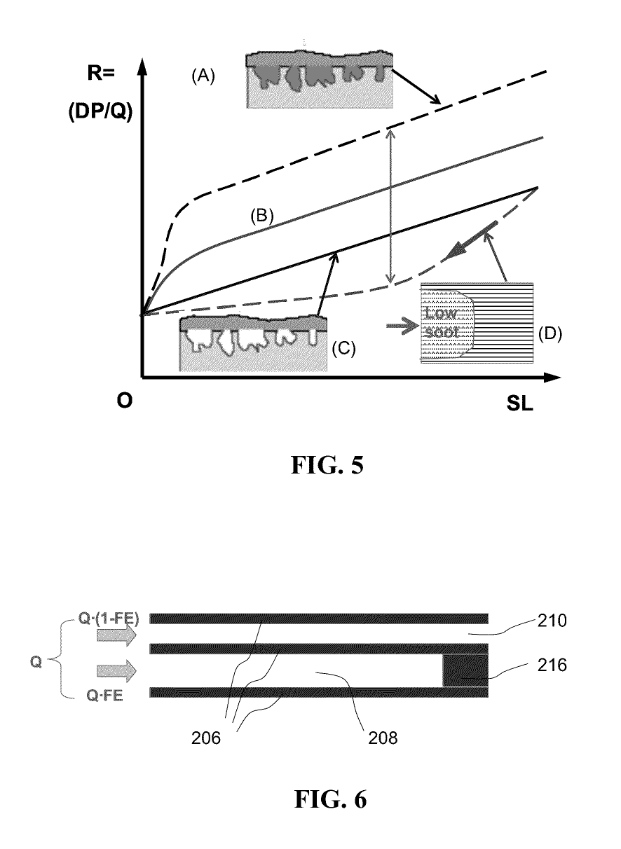

FIG. 5 illustrates a schematic representation of pressure drop response as function of soot load for a full wall-flow particulate filter. For a full wall-flow filter, pressure drop is usually a function of soot load. Curve (A) in FIG. 5 shows a pressure drop response for a through-wall filter having significant deep bed soot accumulation. Curve (B) shows a pressure drop response for a through-wall filter having intermediate deep bed soot accumulation. Curve (C) shows a pressure drop response for a through-wall filter having no deep bed soot accumulation. Curve (D) shows a pressure drop response for a through-wall filter having non-evenly distributed soot due to strong passive regeneration conditions.

FIG. 6 illustrates a schematic representation of flow distribution for a partial wall-flow filter according to an exemplary embodiment of the disclosure. FIG. 6 shows flow distribution for a ceramic partial filter with open inlet channels and closed channels (plugged at the outlet end). The unplugged channels are flow-through channels 210 constituting a bypass region of the partial filter. The channels 208 plugged at the outlet end constitute a filtration region of the partial filter. Flow Q is divided (split) and the split ratio determines filtration efficiency, FE, as derived by the following equations.

$$Δ {P}_{OC} = Δ {P}_{CC}$$

$${R}_{OC} \cdot Q \cdot ( 1 - FE ) = Q \cdot FE \cdot {R}_{CC}$$

$$FE = \frac{1}{1 + \frac{{R}_{CC}}{{R}_{OC}}}$$

Where Q is the total fluid flow, ΔP_{OC} and ΔP_{CC} are the change in pressure across the bypass channels and the plugged channels, respectively, and R_{OC} and R_{CC} are the resistance to flow of the bypass channels and the plugged channels, respectively. Therefore, the deep bed response induces higher flow resistance to through-wall and thus less flow proceeds through-wall, leading to less filtration efficiency.

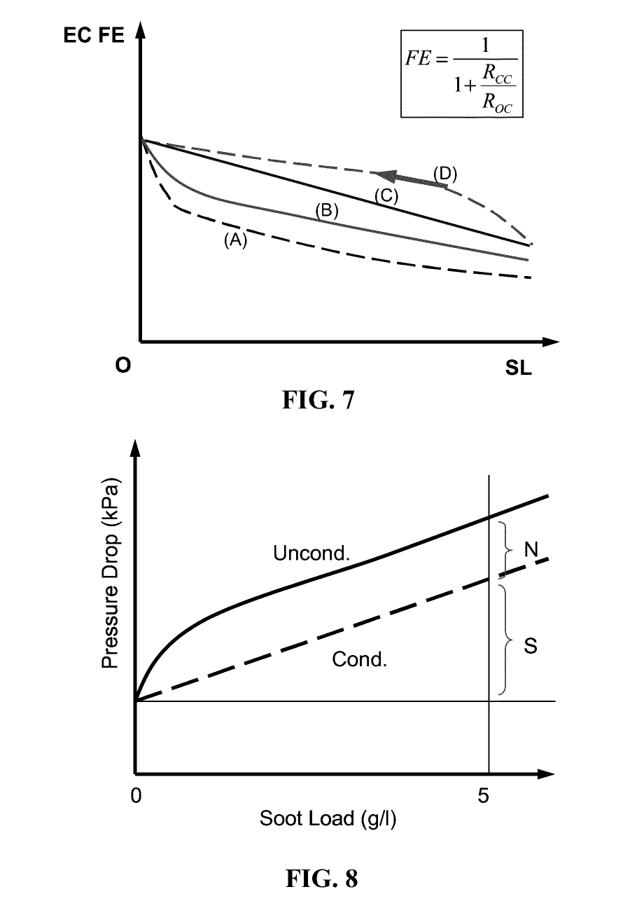

FIG. 7 is a schematic representation of filtration efficiency as a function of soot load for a full wall-flow particulate filter. Curve (A) in FIG. 7 shows a filtration efficiency response for a through-wall filter having significant deep bed soot accumulation. Curve (B) shows a filtration efficiency response for a through-wall filter having intermediate deep bed soot accumulation. Curve (C) shows a filtration efficiency response for a through-wall filter having no deep bed soot accumulation. Curve (D) shows a filtration efficiency response for a through-wall filter having non-evenly distributed soot due to strong passive regeneration conditions. By managing deep bed soot according to exemplary embodiments of the present teachings, improved filtration efficiency can be achieved.

FIG. 8 is a schematic representation of pressure drop response for a full wall-flow filter. As illustrated in FIG. 8, N is a pressure drop difference induced by deep bed soot and S is a pressure drop change from 0 grams per liter (g/L) to 5 g/l for a conditioned curve. The conditioned curve has substantially no deep bed soot, instead, the pressure drop is induced by cake bed soot. The channel walls containing deep bed soot may develop a cake bed layer on the channel walls. Under passive regeneration conditions, the deep bed soot may be burned out of the channel wall while the cake bed soot layer continues to accumulate particulate material. In essence, the channel wall microstructure is free of deep bed soot except for residue from the soot burn out while the cake bed soot layer remains. Such a channel wall state may exist in a conditioned filter.

As shown in FIG. 8, depending on raw material and coating combinations, a full flow-through filter exhibits very different deep bed response. The upper curve is the unconditioned curve, which has the deep bed contribution, while the lower curve is the conditioned curve, without deep bed contribution. N is pressure drop difference induced by deep bed response, S is pressure drop change from 0 g/L to 5 g/L for the conditioned curve. A filter material which has less deep bed response (lower N/S ratio) in its bare state is preferred for a partial flow-through filter according to exemplary embodiments of the present disclosure.

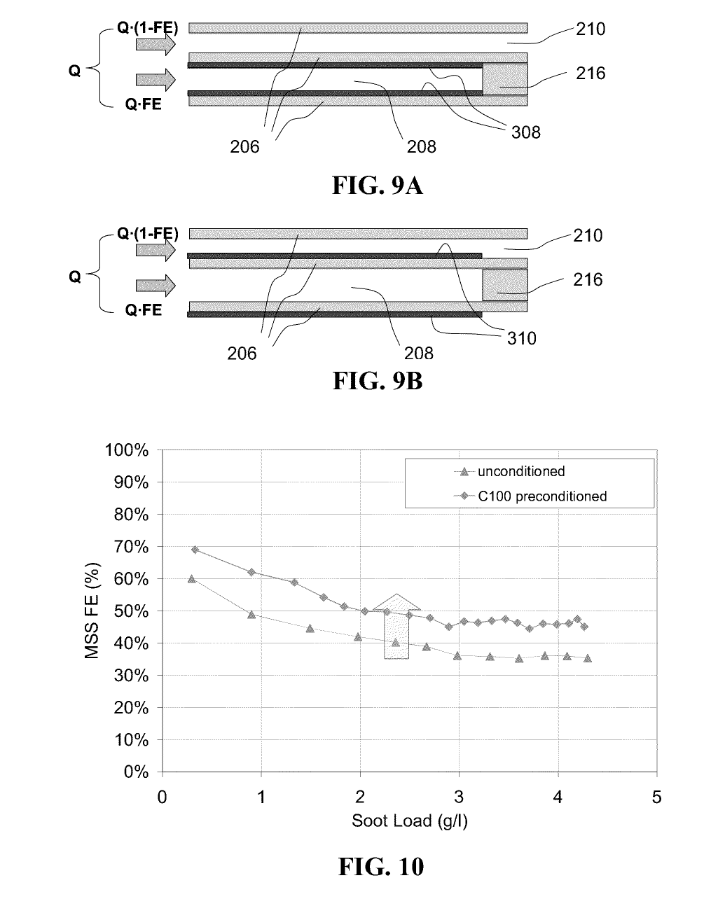

A coating layer may create more deep bed effects compared to a bare filter (comparable N/S ratio) according to exemplary embodiments of the present disclosure. In addition, as illustrated in FIGS. 9A and 9B, the coating layer location can also be optimized to reduce deep bed soot accumulation. FIG. 9A shows the coating layer disposed on the channel walls of a filtration region channel such as may be found in a full flow-through filter. This arrangement may lead to an additional contribution to deep bed soot accumulation by the coating layer. FIG. 9B shows the coating location for a partial flow-through filter according to exemplary embodiments of the teachings herein. In the case of FIG. 9B for the partial flow-through filter, the coating layer can be coated at the outlet channel which does not see soot and thus no additional contribution to deep bed soot accumulation by the coating layer is expected.

FIG. 10 illustrates an operation strategy according to an exemplary embodiment of the present disclosure developed to provide clean wall microstructure and a minimum amount of soot layer covering the channel wall filtration surface area. In FIG. 10, the partial flow-through filter preconditioned with C100 shows much better filtration efficiency then the one that is not conditioned. The C100 preconditioning limits deep bed soot accumulation and improves filtration efficiency. C100 is preconditioning close to an engine rated power conditions.

### Examples

In Table 1 the results of measurements on a few different materials are presented. The N/S ratios of these Examples were measured through diesel particulate filter (DPF) pressure drop testing.

TABLE 1

| | Example AC | Example CO | Example Dev TWF |
|---|---|---|---|
| | coated w/ | coated w/ | coated w/ |
| | oxidation catalyst | oxidation catalyst | oxidation catalyst |
| N/S | 0.3 | 0.5 | 0.1 |

Thus, exemplary embodiments of the disclosure provide a partial through-wall filter having a low N/S ratio filter wall material for improved filtration efficiency. For example, the N/S ratio of the filter material may be less than or equal to about 0.5, less than or equal to about 0.3, less than or equal to about 0.1, or even 0. An N/S ratio of 0 indicates there is no deep bed soot in the filter walls.

Exemplary embodiments of the disclosure also improve a method of operating an exhaust system with a partial through-wall filter having a low N/S ratio filter wall material for improved filtration efficiency.

Reference throughout this specification to exemplary embodiments and similar language throughout this specification may, but do not necessarily, refer to the same embodiment. Furthermore, the described features, structures, or characteristics of the subject matter described herein with reference to an exemplary embodiment may be combined in any suitable manner in one or more exemplary embodiments. In the description, numerous specific details are provided, such as examples of, materials, coatings, channel and filter geometry, etc., to provide a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The methods described above are generally set forth as logical flow. As such, the depicted order and labeled steps are indicative of representative embodiments. Other steps and methods may be conceived that are equivalent in function, logic, or effect to one or more steps, or portions thereof, of the methods illustrated in the schematic diagrams. Additionally, the format and symbols employed are provided to explain the logical steps of the schematic diagrams and are understood not to limit the scope of the methods illustrated by the diagrams. Additionally, the order in which a particular method occurs may or may not strictly adhere to the order of the corresponding steps shown.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A partial wall-flow filter, comprising:
a honeycomb structure comprising an inlet end, an outlet end, and a plurality of parallel channels disposed and configured to flow fluid from the inlet end to the outlet end, the channels being defined by a plurality of porous walls;
at least one filtration region and at least one bypass region, wherein the filtration region comprises a channel plugged at the outlet end, and the bypass region comprises an unplugged channel; and
an N/S ratio of the filter material is less than or equal to about 0.5, wherein N is a pressure drop difference of the filter material in a full wall-flow filter induced by deep bed soot and S is a pressure drop change of the filter material in a full wall-flow filter from 0 grams per liter (g/L) to about 5 g/L for a conditioned curve induced by cake bed soot.

2. The partial wall-flow filter of claim 1, wherein the partial wall-flow filter comprises a ceramic material of at least one of cordierite, aluminum titanate (AT), and silicon carbide.

3. The partial wall-flow filter of claim 1, further comprising a coating disposed on wall surfaces of the bypass region,
wherein wall surfaces of the filtration region do not have the coating disposed thereon.

4. The partial wall-flow filter of claim 3, wherein the N/S ratio is less than or equal to 0.3.

5. The partial wall-flow filter of claim 3, wherein the N/S ratio is less than or equal to 0.1.

6. The partial wall-flow filter of claim 3, wherein the channel of the filtration region has a greater hydraulic diameter than the channel of the bypass region.

7. The partial wall-flow filter of claim 3, further comprising the coating disposed inside walls of the bypass region.

8. The partial wall-flow filter of claim 1, further comprising a coating disposed inside the walls of the bypass region.

9. The partial wall-flow filter of claim 1, further comprising a condition layer disposed on wall surfaces of the bypass region and the filtration region, the condition layer comprising soot or ash,
wherein the porous walls are substantially free of deep bed soot.

10. The partial wall-flow filter of claim 9, wherein the N/S ratio is less than or equal to 0.3.

11. The partial wall-flow filter of claim 9, wherein the N/S ratio is less than or equal to 0.1.

12. The partial wall-flow filter of claim 9, wherein the channel of the filtration region has a greater hydraulic diameter than the channel of the bypass region.

13. The partial wall-flow filter of claim 1, wherein the N/S ratio is less than or equal to 0.3.

14. The partial wall-flow filter of any one of claim 1, wherein the N/S ratio is less than or equal to 0.1.

15. The partial wall-flow filter of claim 1, wherein the channel of the filtration region has a greater hydraulic diameter than the channel of the bypass region.

16. A method of operating an exhaust system, comprising:
directing exhaust gas having particulate matter entrained therein to a partial wall-flow filter having an inlet end, an outlet end, and a plurality of parallel channels disposed and configured to flow fluid from the inlet end to the outlet end, the channels being defined by a plurality of porous walls, the partial wall-flow filter comprising at least one filtration region and at least one bypass region, wherein the filtration region comprises a channel plugged at the outlet end, and the bypass region comprises an unplugged channel, the partial wall-flow filter comprising an N/S ratio of the filter material is less than or equal to about 0.5, wherein N is a pressure drop difference of the filter material in a full wall-flow filter induced by deep bed soot and S is a pressure drop change of the filter material in a full wall-flow filter from 0 grams per liter (g/L) to about 5 g/L for a conditioned curve induced by cake bed soot; and
passing the exhaust gas having particulate matter entrained therein through the partial wall-flow filter wherein some of the particulate matter is captured and some passes through the flow through channels.

17. The method of claim 16, further comprising:
depositing deep bed soot in the porous walls;
depositing cake bed soot on the porous walls; and
burning out the deep bed soot from within the porous walls while maintaining a layer of cake bed soot on the porous walls.
